(19) United States
(12) Patent Application Publication
(10) Pub. No.: US 2009/0249688 A1
(43) Pub. Date: Oct. 8, 2009

(54) BIODEGRADABLE PLANT POTS

(76) Inventors: Gail CAMERON, Hamilton (CA); Paul STYLES, Beamsville (CA)

Correspondence Address: DIMOCK STRATTON LLP, 20 QUEEN STREET WEST, 32nd FLOOR, BOX 102, TORONTO, ON, M5H 3R3, CA

(21) Appl. No.: 12/098,666

(22) Filed: Apr. 7, 2008

(51) Int. Cl. A01G 9/02

(52) U.S. Cl. 47/65.7; 47/66.7; 47/74

(57) ABSTRACT

A biodegradable plant pot comprising at least one container wall for containing a growing medium and a container base attached to said at least one container wall, whereby said at least one container wall and said container base are made of ply-starch material.

### FIELD OF THE INVENTION

The present invention relates to the field of biodegradable containers, specifically biodegradable plant pots.

### BACKGROUND OF THE INVENTION

Biodegradable plant pots are known in the nursery and greenhouse industry. They are often used in growing seedlings, a young plant developing out of a plant embryo from a seed, which are transplanted into the ground after the seedling approaches maturity. The advantage of a biodegradable plant pot is that they can be planted along with the growing medium and the seedling without impeding the root development of the seedling because the biodegradable plant pot breaks down and degrades after being planted in the soil. Harder pots have a high resin content that require additional time to break down. The end consumer must also cut or crack the bottom of the pot to encourage and facilitate root penetration. These pots typically take four to five years to fully degrade.

Therefore, it would be advantageous to have a biodegradable plant pot that fully degrades within one year, thus allowing the grower to transplant the biodegradable plant pot, the growing medium, and the seedling without having to break the bottom of the biodegradable plant pot to facilitate root development.

Biodegradable plant pots are also used in automated seedling production factories. These factories produce potted seedlings on an assembly line. There are several problems identified in the biodegradable pots in the prior art. In the production process, the plant pots are typically lifted and transported by robotic arms. Some of the biodegradable plant pots in the prior art are too brittle, and break when handled by robotic arms. Additionally, the plant pots are typically subjected to heat and moisture in the production process. Some of the biodegradable plant pots in the prior art react to moisture and heat, sometimes causing swelling and other times causing a weakening of the material. Deformations and irregularities in the biodegradable plant pots may make it more difficult for the robotic arms to grip and transport the plant pots. Additionally plant pots which have been weakened may be broken during the production process.

Thus, it would be advantageous to have biodegradable plant pots that are resilient enough to not break when handled by the robotic arms in the production process. Furthermore, it would also be advantageous to have biodegradable plant pots that did not deform or weaken when subjected to conditions typical of the production process.

After the seedling production process, the biodegradable plant pots are often stored on greenhouse benches and subjected to moisture and heat. Some of the plant pots of the prior art break down while in storage, making them difficult to transport to retailers.

Thus, it would be advantageous to have a biodegradable plant pot that is resilient to post-production storage conditions, and only break down in compost conditions. In particular, it would be advantageous to have a biodegradable plant pot that only degrades after the plant has been transplanted into the ground.

### SUMMARY OF THE INVENTION

In one embodiment the invention provides a method of using a biodegradable plant pot wherein the plant pot comprises a container wall for containing a growing medium and a container base attached to the container wall. The container wall and the container base are primarily made of ply-starch (PSM) material. The method comprises placing a seedling and growing medium in the biodegradable plant pot, storing the biodegradable plant pot on a greenhouse bench to allow the seedling to approach maturity, transplanting the biodegradable plant pot directly into the ground, wherein the biodegradable plant pot is completely degradable within one year of being transplanted into the ground.

In another embodiment the invention provides a biodegradable plant pot comprising at least one container wall for containing a growing medium and a container base attached to said at least one container wall, whereby said at least one container wall and said container base are primarily made of ply-starch (PSM) material.

In another embodiment the invention provides the use of ply-starch (PSM) material to form a biodegradable plant pot comprising at least one container wall for containing a growing medium and a container base attached to said at least one container wall.

### BRIEF DESCRIPTION OF THE DRAWINGS

In drawings which illustrate by way of example only a preferred embodiment of the invention,

FIG. 1 is an isometric view of an embodiment of the invention

### DETAILED DESCRIPTION OF THE INVENTION

The biodegradable plant pots made of primarily PSM ply starch material were developed in order to address the need of a renewable resource pot, that would not inhibit the current growing practices of growers and that would address the end consumer's needs and reduce the reliance on plastic pots currently used by the grower industry. These biodegradable plant pots have been tested to withstand the typical growing cycles on the greenhouse bench and they do not breakdown when utilized in a typical commercial operation. These biodegradable plant pots can be planted in the ground as the PSM will break down and allow the root systems to develop. These biodegradable plant pots have been molded in order to allow proper uptake and drainage for flood benches and floors, and to be able to be separated by many pot filling machines and to be picked up and moved by industry bench robots. The pot does not crack upon impact so it is durable in commercial growing operations. In addition the pot does not require the end consumer to crack it open or cut off the bottom in order to allow for root system penetration.

Molds are designed and manufactured in various shapes and sizes. Sheets made of primarily PSM (ply starch material) are used in a blow mold process to produce the biodegradable plant pots. Molds are also designed to utilize the injection molding process.

The biodegradable plant pots of the present invention are produced using a starch-based biological complete degradation material as described in Chinese Patent No. 01138290.2, which is incorporated herein by reference. The material is also known as ply-starch material (“PSM” for short). The material is made from consecutive reactions of “the extruder and plating machine for biological complete degradation material” as described in Chinese Patent No. 02115416.3, which is incorporated herein by reference. The material is subjected to certain temperature, pressure, and shearing force, using starch as the main raw material and with a reactive accessory ingredient.

Because the material is starch-based, it is completely degradable and ecologically neutral, making PSM ideal for packages with deformability independently just like plastic. The starch in the PSM has lost its inherent characteristics like strong hydroscopic property, low wet strength, rigid & fragile dry strength, and no thennoplastic deformability, etc. PSM has thermoplastic characteristics much like plastic, making it capable of being formed using methods such as extrusion, plus pressure, negative pressure, injection mold, blow molding, and foaming, etc. PSM has certain characteristics such as rigidity, flexibility, ductility, elasticity, water, oil and solvent preventability. PSM belongs to the group of biological complete degradation material as it uses starch as main raw material, and also as its accessory ingredient.

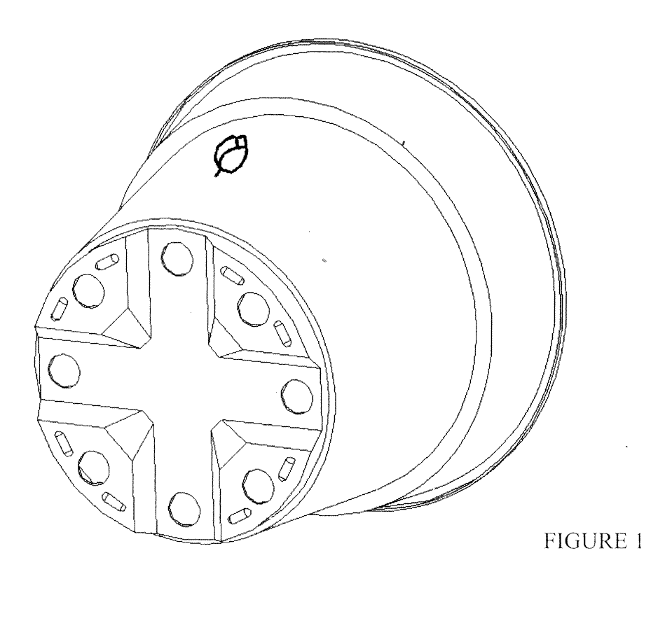

An embodiment of the invention is shown in FIG. 1. FIG. 1 shows a biodegradable plant pot with a container bottom which has apertures. The apertures allow excess water in the biodegradable plant pot to drain.

Various embodiments of the present invention having been thus described in detail by way of example, it will be apparent to those skilled in the art that variations and modifications may be made without departing from the invention.

What is claimed is:

1. A biodegradable plant pot comprising at least one container wall for containing a growing medium and a container base attached to said at least one container wall, whereby said at least one container wall and said container base are primarily made of ply-starch (PSM) material.

2. The biodegradable plant pot of claim 1, wherein said container base has a plurality of apertures for allowing moisture to pass through.

3. The biodegradable plant pot of claim 1, wherein said container walls and said container base are resilient to deformation.

4. The biodegradable plant pot of claim 1, wherein said container walls and said container base are resistant to biodegradation unless in compost conditions.

5. The biodegradable plant pot of claim 1, wherein said container walls and said container base are completely biodegradable when placed in compost conditions.

6. The biodegradable plant pot of claim 5, wherein said container walls and said container base completely biodegrade within one year when placed in compost conditions.

7. The use of ply-starch material to form a biodegradable plant pot comprising at least one container wall for containing a growing medium and a container base attached to said at least one container wall.

8. The use of claim 7, wherein said container base has a plurality of apertures for allowing moisture to pass through.

9. The use of claim 8 wherein the biodegradable plant pot is resilient to deformation.

10. The use of claim 7 wherein said container walls and said container base are resistant to biodegradation unless in compost conditions.

11. The use of claim 1, wherein said container walls and said container base are completely biodegradable when placed in compost conditions.

12. The use of claim 11, wherein said container walls and said container base are completely biodegradable within one year when placed in compost conditions.

13. A method of using a biodegradable plant pot, said plant pot comprising a container wall for containing a growing medium and a container base attached to the container wall, whereby the container wall and the container base are made of ply-starch material, the method comprising:
placing a seedling and growing medium in said biodegradable plant pot,
storing the biodegradable plant pot on a greenhouse bench to allow the seedling to approach maturity,
transplanting said biodegradable plant pot directly into the ground,
wherein said biodegradable plant pot will completely degrade within one year of being transplanted into the ground.
